(19) United States
(12) Patent Application Publication
(10) Pub. No.: US 2025/0105394 A1
(43) Pub. Date: Mar. 27, 2025

(54) BATTERY PACK AND BATTERY COOLING SYSTEM

(71) Applicant: HONDA MOTOR CO., LTD., Tokyo (JP)

(72) Inventor: Yasushi OGIHARA, Saitama (JP)

(73) Assignee: HONDA MOTOR CO., LTD., Tokyo (JP)

(21) Appl. No.: 18/827,909

(22) Filed: Sep. 9, 2024

(30) Foreign Application Priority Data
Sep. 27, 2023 (JP) 2023-165281

(51) Int. Cl. H01M 10/6556; H01M 10/613; H01M 10/625; H01M 10/63; H01M 10/6563; H01M 10/6568

(52) U.S. Cl. CPC H01M 10/6556; H01M 10/613; H01M 10/63; H01M 10/6563; H01M 10/6568; H01M 10/625

(57) ABSTRACT

A battery pack includes plural cells each having a positive electrode terminal and a negative electrode terminal; plural battery modules in which the plural cells are laminated; a battery case in which the plural battery modules are accommodated; a water jacket disposed on the battery case or inside the battery case and configured to allow a first refrigerant to flow through the water jacket and perform heat exchange with the plural battery modules; a heat exchanger disposed on the battery case or inside the battery case and configured to allow a second refrigerant to flow through the heat exchanger and perform heat exchange with air inside the battery case; and a fan disposed on the battery case or inside the battery case and configured to allow air inside the battery case to circulate.

### CROSS-REFERENCE TO RELATED APPLICATION

This application is based on and claims priority under 35 USC 119 from Japanese Patent Application No. 2023-165281 filed on Sep. 27, 2023.

### TECHNICAL FIELD

The present invention relates to a battery pack mountable on a moving object such as a vehicle, and a battery cooling system.

### BACKGROUND ART

In recent years, attempts have been made to realize a low carbon social or a decarburized social, and research and development have been performed on an electrification technology in order to reduce CO₂ emissions and improve energy efficiency even in vehicles.

Batteries play an important role in the electrification technique. Since the battery is a heat-generating component, from the viewpoint of safety and prevention of battery deterioration, current is limited when the battery reaches a predetermined temperature or higher. Therefore, for example, a water jacket is provided in a battery pack, and battery cooling control is performed so that a temperature of the battery is maintained within a desired temperature range.

JP2003-297439A describes that a water jacket is provided between batteries arranged in a plurality of rows, and a cooling fan is provided to supply air from a rear side to a front side of a battery case.

### SUMMARY OF INVENTION

In recent battery development, a heat resistance temperature of cells constituting a battery module becomes higher. Therefore, it was sufficient to cool the cells that constitute the battery module in the conventional art, but in recent years, although temperatures of the cell do not reach a critical temperature that limits a current, there is a risk that terminal temperatures of the cells reach the critical temperature that limits the current.

A battery cooling method described in JP2003-297439A can cool a surface of the battery module on an outer side in a vehicle width direction by the air supplied by the cooling fan, but does not mention cooling for cell terminals.

The present invention provides a battery pack and a battery cooling system capable of cooling a cell body of a battery module and capable of appropriately cooling a cell terminal.

A battery pack according to the present invention including:
a plurality of cells each having a positive electrode terminal and a negative electrode terminal;
a plurality of battery modules in which the plurality of cells are laminated;
a battery case in which the plurality of battery modules are accommodated;
a water jacket disposed on the battery case or inside the battery case and configured to allow a first refrigerant to flow therethrough and perform heat exchange with the plurality of battery modules;
a heat exchanger disposed on the battery case or inside the battery case and configured to allow a second refrigerant to flow therethrough and perform heat exchange with air inside the battery case; and
a fan disposed on the battery case or inside the battery case and configured to allow air inside the battery case to circulate.

A battery cooling system according to the present invention including:
the above battery pack;
a refrigerant circuit configured to allow the first refrigerant flowing through the water jacket to circulate;
a heat pump circuit configured to allow the second refrigerant flowing through the heat exchanger to circulate;
a second heat exchanger configured to perform heat exchange between the first refrigerant and the second refrigerant; and
a control unit configured to control the heat exchanger, the second heat exchanger, and the fan.

According to the present invention, the cell body of the battery module can be cooled, and the cell terminal can also be appropriately cooled.

### BRIEF DESCRIPTION OF DRAWINGS

FIG. 1 is an exploded perspective view of a battery pack 1 according to a first embodiment.

FIG. 2 is an exploded perspective view of a battery module 10.

FIG. 3 is a perspective view of a laminated cell 21.

FIG. 4 is a perspective view showing a bus bar 22 connecting electrode tabs 212 of the laminated cells 21.

FIG. 5 is a plan view showing an internal structure of the battery pack 1.

FIG. 6 is a cross-sectional view taken along a line A-A of FIG. 5.

FIG. 7 is a cross-sectional view taken along a line B-B of FIG. 5.

FIG. 8 is a cross-sectional view taken along a line C-C of FIG. 5.

FIG. 9 is a cross-sectional view taken along a line D-D of FIG. 5.

FIG. 10 is a plan view showing the internal structure of the battery pack 1, which schematically shows a flow of air caused by a fan 13.

FIG. 11 is a diagram showing a battery cooling system 100.

FIG. 12 is a timing chart of battery cooling control when quick charging is started in a state in which a cell temperature is lower than a cell cooling start temperature by a predetermined value or more.

FIG. 13 is a timing chart of battery cooling control when the quick charging is started in a state in which the cell temperature is close to the cell cooling start temperature.

FIG. 14 is a plan view showing an internal structure of a battery pack 1A according to a second embodiment, and schematically shows the flow of air caused by the fan 13.

FIG. 15 is a cross-sectional view taken along a line E-E of FIG. 14.

### DETAILED DESCRIPTION OF THE INVENTION

Hereinafter, a battery pack of each embodiment of the present invention will be described with reference to the accompanying drawings.

### First Embodiment

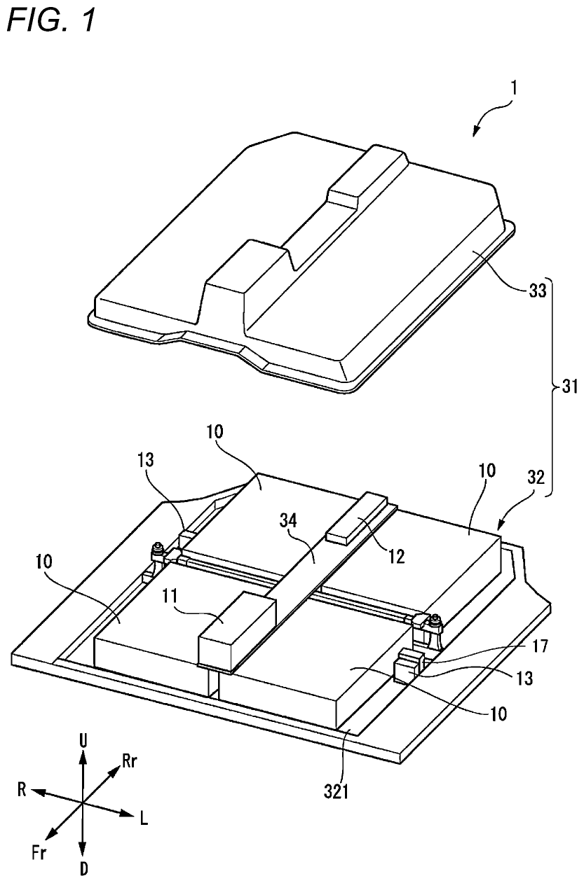

A battery pack 1 according to a first embodiment of the present invention is configured to be able to be mounted on an electric vehicle such as a hybrid vehicle, an electric automobile, or a fuel cell vehicle. As shown in FIG. 1, the battery pack 1 includes four battery modules 10, a junction box 11, an auxiliary device 12, and a battery case 31 that accommodates the above. The four battery modules 10 are arranged in two rows in a front-rear direction and in two rows in a left-right direction. Note that the number of battery modules 10 can be freely set as long as there are two or more, and arrangement thereof is not particularly limited.

The battery modules 10 are electrically connected to each other via an electrical connection member (not shown). Electric power stored in the battery modules 10 is supplied to a motor or the like serving as a drive source of the vehicle. Note that in the following description, the four battery modules 10 may be collectively referred to as a battery.

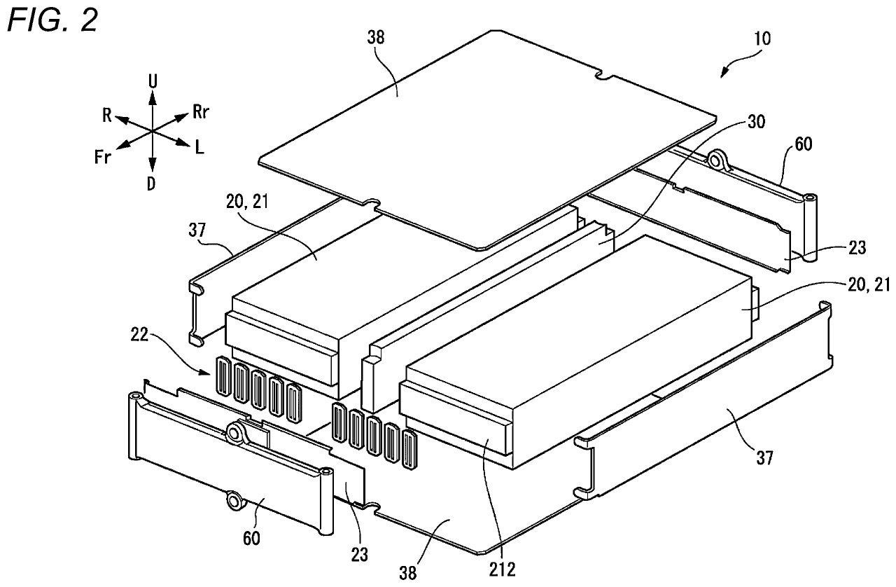

As shown in FIG. 2, the battery module 10 includes a cell laminate 20 in which a plurality of laminated cells 21 are laminated, an intermediate plate 30, a pair of end plates 37, a pair of restraining members 38, and a pair of cover plates 60.

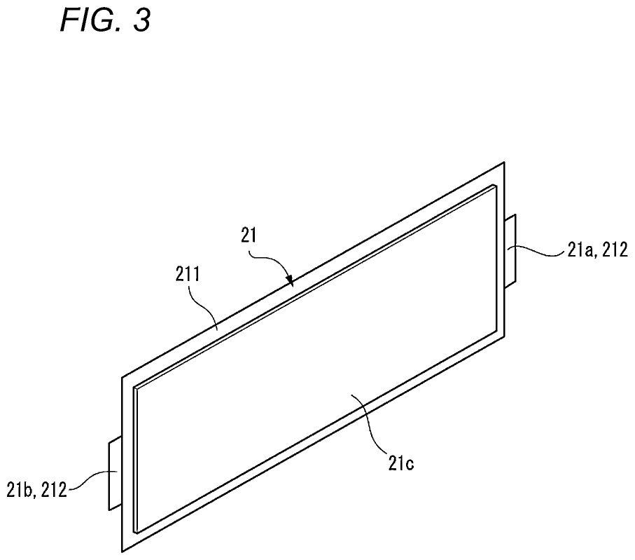

The laminated cell 21 is, for example, a solid-state battery. As shown in FIG. 3, the laminated cell 21 formed of a solid-state battery has a positive electrode to which a positive electrode tab 21a is connected, a negative electrode to which a negative electrode tab 21b is connected, a solid electrolyte disposed between the positive electrode and the negative electrode, and a laminate film 21c accommodating the above, and charging and discharging are performed by transferring lithium ions between the positive electrode and the negative electrode via the solid electrolyte. A sealing portion 211 is provided on a peripheral edge of the laminated cell 21. The positive electrode tab 21a extends from the sealing portion 211 on one end side in a longitudinal direction of the laminated cell 21, and the negative electrode tab 21b extends from the sealing portion 211 on the other end side in the longitudinal direction of the laminated cell 21. Note that the positive electrode tab 21a and the negative electrode tab 21b may both extend from the sealing portion 211 on one end side in the longitudinal direction of the laminated cell 21. Hereinafter, the positive electrode tab 21a and the negative electrode tab 21b are collectively referred to as an electrode tab 212. Note that the laminated cell 21 is not limited to a solid electrolyte, and may be a semi-solid electrolyte or a liquid electrolyte.

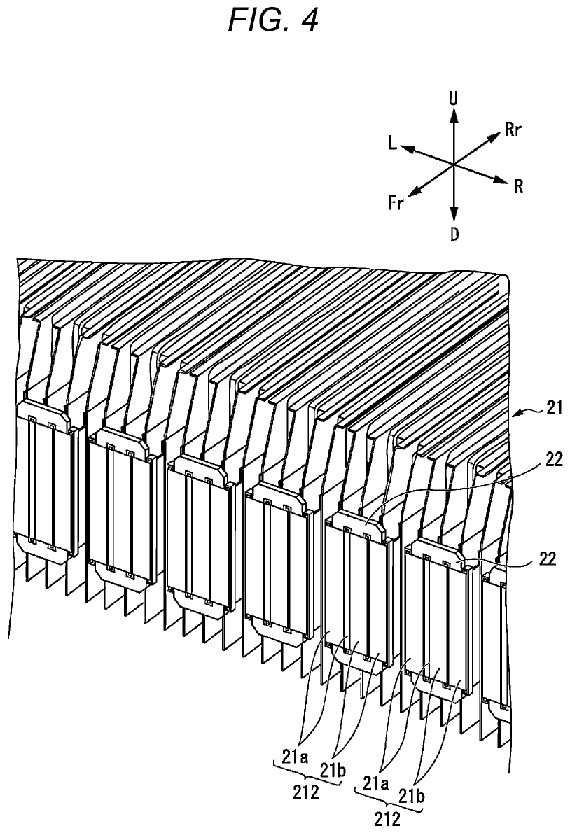

As shown in FIG. 4, the cell laminate 20 is formed by laminating the plurality of laminated cells 21 in the left-right direction. In the present embodiment, each laminated cell 21 is disposed such that the electrode tab 212 extends in the front-rear direction. The laminated cells 21 are electrically connected via a bus bar 22.

Returning to FIG. 2, the intermediate plate 30 is provided at an intermediate portion of the plurality of laminated cells 21 in a lamination direction (here, the left-right direction). Two or more intermediate plates 30 may be provided.

The pair of end plates 37 are provided at both ends of the plurality of laminated cells 21 in the lamination direction.

The pair of restraining members 38 face each other in an upper-lower direction, are coupled to the pair of end plates 37 to restrain the plurality of laminated cells 21. Here, the pair of restraining members 38 each has a plate shape, and cover the plurality of laminated cells 21, the intermediate plate 30, and the pair of end plates 37 in the upper-lower direction. In this example, the restraining member 38 has a plate shape, but as long as the end plate 37 can be restrained in the lamination direction, a shape of the restraining member 38 does not need to cover the cells such as a ladder shape or restraint by a rod.

The pair of cover plates 60 are provided outside the plurality of laminated cells 21 in the front-rear direction and extend in the lamination direction. As viewed in the front-rear direction, the cover plate 60 covers the bus bars 22 and the electrode tabs 212 of the respective laminated cells 21 via a bus bar cover 23 having an electrical insulation property, and protects the bus bars 22 and the electrode tabs 212.

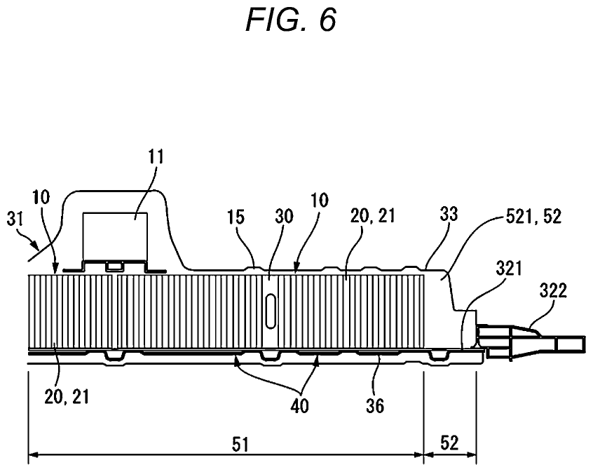

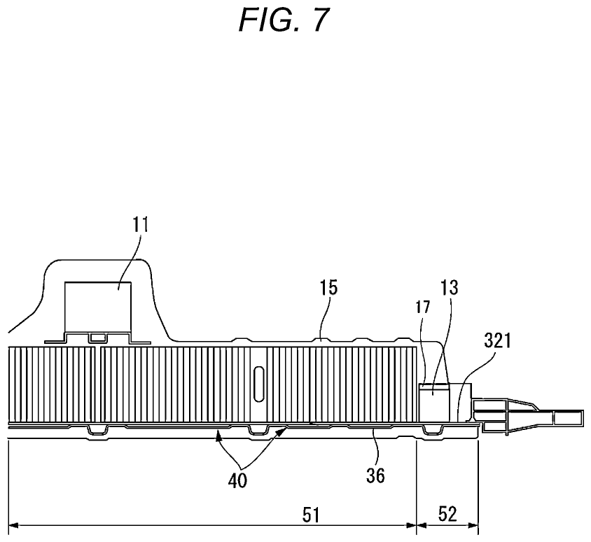

Returning to FIG. 1, the battery case 31 includes a battery tray 32 on which the plurality of battery modules 10 are placed, and an upper cover 33 that covers the battery modules 10 from above. As shown in FIGS. 6, 7, and 9, an upper gap 15 is provided between the battery modules 10 and the upper cover 33.

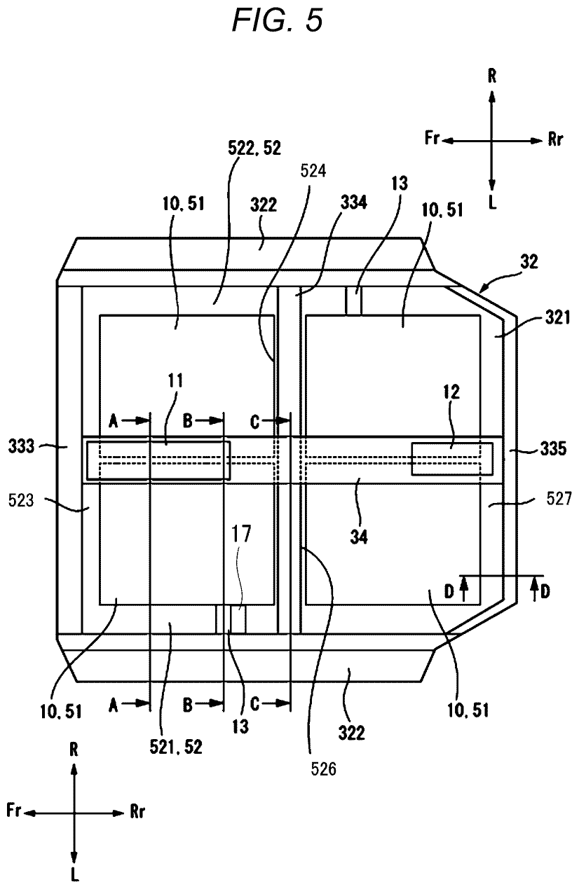

As shown in FIG. 5, the battery tray 32 includes a bottom plate 321 on which the battery modules 10 are placed, a pair of side frames 322 provided on left and right sides of the bottom plate 321, respectively, a front cross member 333, a central cross member 334, and a rear cross member 335 that couple the pair of side frames 322.

The front cross member 333 constitutes a front wall of the battery case 31, and the rear cross member 335 constitutes a rear wall of the battery case 31. The central cross member 334 divides the inside of the battery case 31 into two front and rear spaces. Two battery modules 10 are disposed on the left and right in the front space, and two battery modules 10 are disposed on the left and right in the rear space.

An upper frame 34 extending in the front-rear direction is bridged over the two battery modules 10 positioned on the left side and the two battery modules 10 positioned on the right side at left and right center portions of the battery case 31. On the upper frame 34, the junction box 11 is disposed on a front side thereof, and the auxiliary device 12 is disposed on a rear side thereof. In the junction box 11, electronic components such as a conductive member, a fuse, and a comparator that connect an electric power system inside the battery case 31 and a DC line outside the battery case 31 are disposed. The auxiliary device 12 is, for example, a battery ECU.

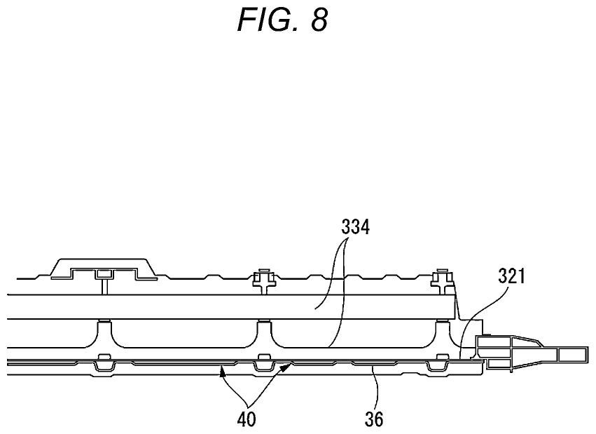

As shown in FIGS. 6 to 9, a cover plate 36 is attached below the bottom plate 321, and a water jacket 40 is formed between the bottom plate 321 and the cover plate 36.

The water jacket 40 is provided over substantially an entire surface of the bottom plate 321. In an internal space of the battery case 31, when a region where the battery modules 10 are disposed is defined as a first section 51 and a region where the battery modules 10 are not disposed is defined as a second section 52, the water jacket 40 is provided over the first section 51 and the second section 52. In the first section, heat exchange is performed between the battery modules 10 and the water jacket 40. The battery modules 10 and the bottom plate 321 may be in direct contact with each other or indirect contact with each other via a heat transfer material.

The second sections 52 are provided above the water jacket 40, outside the first section 51 and on both left and right sides. That is, the second sections 52 have a left gap 521 between the two battery modules 10 positioned on the left side and the side frame 322 on the left side, and a right gap 522 between the two battery modules 10 positioned on the right side and the side frame 322 on the right side.

The inside of the battery case 31 has a front gap 523 between the two battery modules 10 positioned on the front side and the front cross member 333, a central front gap 524 between the two battery modules 10 positioned on the front side and the central cross member 334, a central rear gap 526 between the two battery modules 10 positioned on the rear side and the central cross member 334, and a rear gap 527 between the two battery modules 10 positioned on the rear side and the rear cross member 335. The front gap 523, the central front gap 524, the central rear gap 526, and the rear gap 527 form air paths orthogonal to extending directions of the left gap 521 and the right gap 522 constituting the second sections 52 and connecting the left gap 521 and the right gap 522.

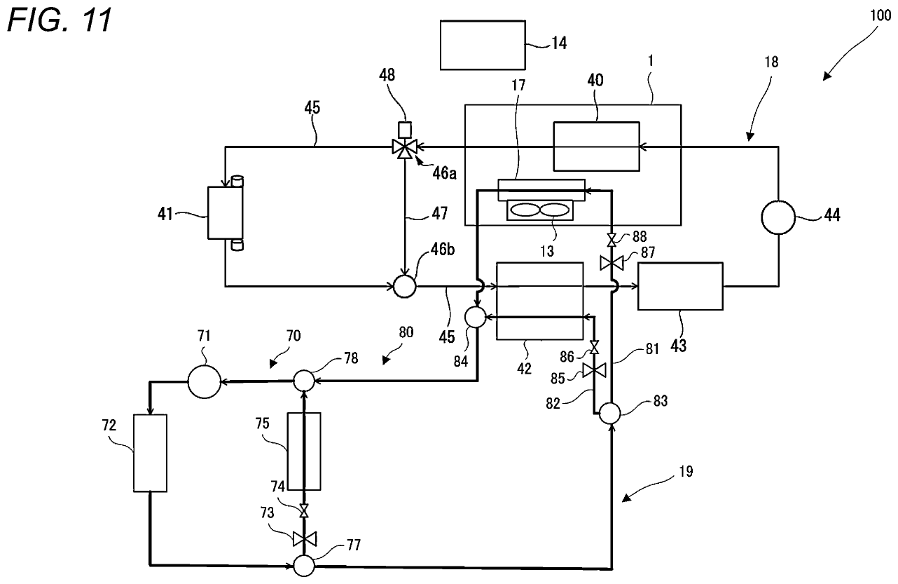

The water jacket 40 is connected to a battery cooling circuit 18 of a battery cooling system 100 shown in FIG. 11. The battery cooling system 100 includes the battery cooling circuit 18 in which a first refrigerant (for example, LLC) that flows through the water jacket 40 circulates, and a heat pump circuit 19 in which a second refrigerant (for example, a refrigerant for an air conditioner) different from the first refrigerant circulates, a chiller 42 that can perform heat exchange between the first refrigerant and the second refrigerant, a fan 13, and a control unit 14 that controls these.

The battery cooling circuit 18 is provided outside the battery case 31 and is connected to the battery case 31 via a pipe. The battery cooling circuit 18 includes a main flow path 45 including the water jacket 40, a radiator 41, the chiller 42, a heater 43, and an electric pump 44, and a bypass flow path 47 bypassing the radiator 41 of the main flow path 45.

The bypass flow path 47 connects a branch portion 46a positioned between the water jacket 40 and the radiator 41 and a merging portion 46b positioned between the radiator 41 and the chiller 42. The branch portion 46a is provided with a three-way valve 48. The control unit 14 switches the three-way valve 48 between a bypass OFF state and a bypass ON state. When the three-way valve 48 is in the bypass OFF state, the first refrigerant sent out from the electric pump 44 circulates through the water jacket 40, the radiator 41, the chiller 42, and the heater 43. On the other hand, in the bypass ON state, the first refrigerant sent out from the electric pump 44 bypasses the radiator 41 and circulates through the water jacket 40, the chiller 42, and the heater 43. The heater 43 is controlled to be in an ON state and an OFF state by the control unit 14.

The battery cooling circuit 18 is driven by the control unit 14 in a stop mode, a heating mode, a normal mode, and a cooling mode. The stop mode is set, for example, when the vehicle is parked. In the stop mode, the electric pump 44 does not operate. The heating mode is set, for example, when the battery is at a low temperature. In the heating mode, by setting the three-way valve 48 to be in the bypass ON state, the heater 43 can warm the first refrigerant while cutting off heat radiation from the radiator 41, thereby heating the battery. The normal mode is set, for example, when the vehicle is traveling. In the normal mode, the three-way valve 48 is set to be in the bypass OFF state, and the heat of the refrigerant is radiated from the radiator 41 to cool the battery. The cooling mode is set, for example, when the battery is at a high temperature while the vehicle is traveling, or when the vehicle is in charging (including quick charging). In the cooling mode, in addition to radiation the heat of the refrigerant from the radiator 41, the first refrigerant exchanges heat with the second refrigerant of the heat pump circuit 19 in the chiller 42, thereby further cooling the battery. Since a heat exchange capacity of the radiator 41 during charging and the like is limited, heat exchange by the chiller 42 becomes effective.

The heat pump circuit 19 is, for example, a refrigeration cycle for air conditioning of a vehicle. The heat pump circuit 19 includes a main flow path 70 and a battery cooling flow path 80 branching from the main flow path 70. The main flow path 70 includes a compressor 71, a condenser 72, a first shut-off valve 73, a first expansion valve 74, and a first evaporator 75 in this order in a flow direction of the second refrigerant.

The battery cooling flow path 80 connects a first branch portion 77 positioned between the condenser 72 and the first shut-off valve 73 and a first merging portion 78 positioned between the first evaporator 75 and the compressor 71.

The battery cooling flow path 80 is provided with a second branch portion 83 that branches the battery cooling flow path 80 into an evaporator flow path 81 and a chiller flow path 82, and a second merging portion 84 that merges the evaporator flow path 81 and the chiller flow path 82. The chiller flow path 82 includes a second shut-off valve 85, a second expansion valve 86, and the chiller 42 in this order from the second branch portion 83 in a flow direction of the second refrigerant. The evaporator flow path 81 includes a third shut-off valve 87, a third expansion valve 88, and a second evaporator 17 in this order from the second branch portion 83 in the flow direction of the second refrigerant.

In the heat pump circuit 19, the first shut-off valve 73, the second shut-off valve 85, and the third shut-off valve 87 are controlled to be turned on and off by the control unit 14. The control unit 14 controls the first evaporator 75 to the ON state by controlling the first shut-off valve 73 to the ON state when there is a cooling request in a passenger compartment, and controls the first evaporator 75 to the OFF state by controlling the first shut-off valve 73 to the OFF state when there is no cooling request in the passenger compartment.

When a temperature of the laminated cell 21 (hereinafter, referred to as a cell temperature) becomes equal to or higher than a cell cooling start temperature (a first threshold), the control unit 14 controls the second shut-off valve 85 to the ON state to control the chiller 42 to the ON state, and when the cell temperature is lower than the cell cooling start temperature, the control unit 14 controls the second shut-off valve 85 to the OFF state to control the chiller 42 to the OFF state. As a result, when the cell temperature is high, the first refrigerant flowing through the battery cooling circuit 18 is cooled by the chiller 42, thereby improving a cooling capacity of the water jacket 40.

Returning to FIG. 5, when the first refrigerant is supplied to the water jacket 40, the battery module 10 in the first section 51 is cooled via the bottom plate 321. At this time, the laminated cell 21 itself in contact with the bottom plate 321 is well cooled, whereas the electrode tab 212 of the laminated cell 21 separated from the bottom plate 321 is not easily cooled, and a temperature of the electrode tab 212 may exceed a threshold to cause current limitation of the battery.

When the temperature of the electrode tab 212 of the laminated cell 21 (hereinafter, referred to as a tab temperature) becomes equal to or higher than a tab cooling start (a second threshold) temperature, the control unit 14 controls the third shut-off valve 87 to the ON state to control the second evaporator 17 to the ON state and control the fan 13 to the ON state. On the other hand, when the tab temperature is lower than the tab cooling start temperature, the control unit 14 controls the third shut-off valve 87 to the OFF state to control the second evaporator 17 to the OFF state, and control the fan 13 to the OFF state.

In the present disclosure, the fan 13 and the second evaporator 17 are provided inside the battery case 31. When the fan 13 is driven, air circulates through the first section 51 and the second section 52. Since the electrode tab 212 comes into contact with the air circulating inside the battery case 31, the heat of the cell terminal is radiated to the second evaporator 17 when the air passes through the second evaporator 17. Therefore, the electrode tab 212 of the laminated cell 21 can be appropriately cooled.

Two fans 13 are provided inside the battery case 31 according to the present embodiment, one is provided in the right gap 522 of the second section 52 and behind the central cross member 334, and the other one is provided in the left gap 521 of the second section 52 and in front of the central cross member 334. The two fans 13 are disposed to send out air in opposite directions to each other in the front-rear direction. Note that the second evaporator 17 may be provided anywhere as long as it is provided on the battery case 31 or inside the battery case 31. However, in the present embodiment, the second evaporator 17 is disposed adjacent to the rear of the fan 13 provided in the left gap 521.

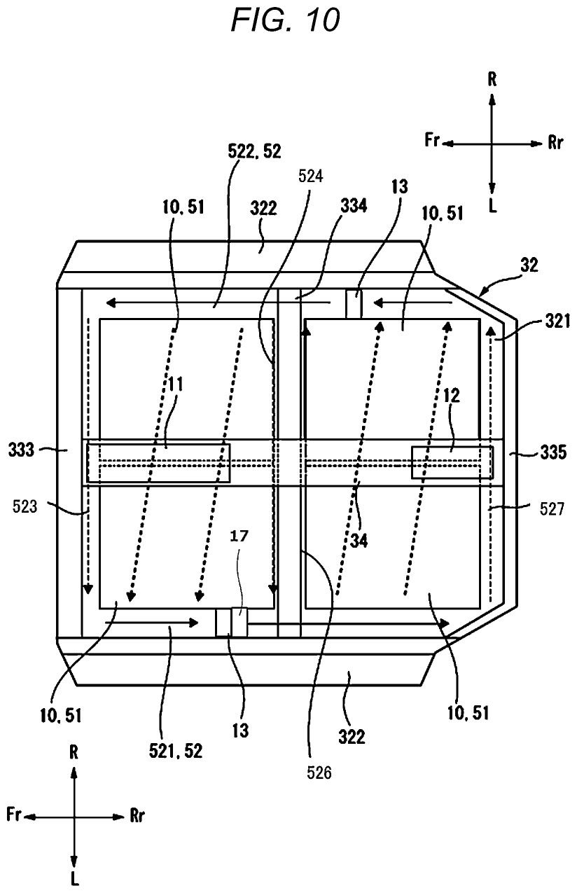

In the present embodiment, as shown in FIG. 10, the fan 13 on the right side sends out air forward, and the fan 13 on the left side sends out air rearward. The air sent out from the fan 13 flows forward or rearward through the gaps around the central cross member 334. Therefore, a front side of the fan 13 on the right side in the right gap 522 becomes a positive pressure region and a rear side thereof becomes a negative pressure region, whereas in the left gap 521, the front side of the fan 13 on the left side becomes a negative pressure region, and the rear side thereof becomes a positive pressure region. As a result, inside the battery case 31, a pressure distribution in the left-right direction is formed from the positive pressure region of the second section 52, the first section 51 (the battery modules 10) and the negative pressure region of the second section 52, and circulation of air inside the battery case 31 can be made smooth.

That is, as shown by arrows in FIG. 10, inside the battery case 31, the air sent out from the fan 13 on the right side flows from the front side of the right gap 522 (the positive pressure region of the fan 13 on the right side), passes through upper portions (the upper gap 15) of the two battery modules 10 positioned on the front side, flows toward the front side of the left gap 521 (the negative pressure region of the fan 13 on the left side), and is sucked into the fan 13 on the left side. The air sent out from the fan 13 on the left side flows from the rear side of the left gap 521 (the positive pressure region of the fan 13 on the left side), passes through upper portions (the upper gap 15) of the two battery modules 10 positioned on the rear side, flows toward the rear side of the right gap 522 (the negative pressure region of the fan 13 on the right side), and is sucked into the fan 13 on the right side. In this way, the upper portion of the laminated cells 21 (the upper portion of the battery modules 10) can be cooled.

Since the junction box 11 attached to the upper frame 34 is disposed above the two battery modules 10 positioned on the front side, the junction box 11 is also cooled. In particular, the conductive member of the junction box 11 comes into contact with the air circulating through the first section 51 and the second section 52, so that current limitation due to heat generated by the conductive member can be avoided.

A part of the air sent out from the fan 13 on the right side flows from the front side of the right gap 522 (the positive pressure region of the fan on the right side), passes through the front gap 523 and the central front gap 524, flows forward the front side of the left gap 521 (the negative pressure region of the fan 13 on the left side), and is sucked into the fan 13 on the left side. A part of the air sent out from the fan 13 on the left side passes through the rear gap 527 and the central rear gap 526, flows toward the rear side of the right gap 522 (the negative pressure region of the fan 13 on the right side), and is sucked into the fan 13 on the right side. In this way, the electrode tabs 212 of the laminated cells 21 can be cooled.

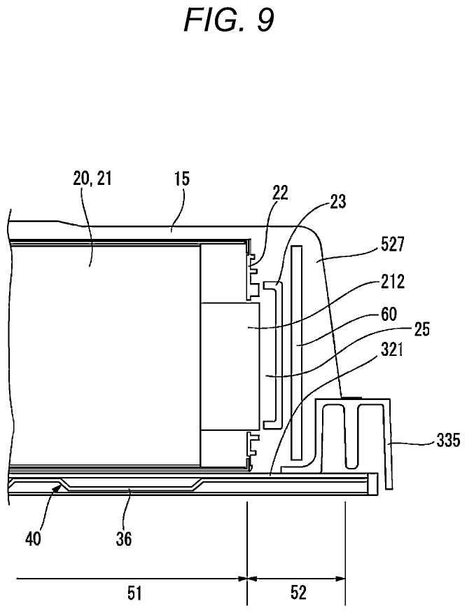

More specifically, as shown in FIG. 9, the air passing through the air paths of the front gap 523, the central front gap 524, the rear gap 527, and the central rear gap 526 cools the electrode tabs 212 of the laminated cells 21 while advancing through spaces 25 formed between the electrode tabs 212 of the laminated cells 21 and the bus bar cover 23 and extending in the lamination direction. In this way, the spaces 25 formed between the electrode tabs 212 of the laminated cells 21 and the bus bar cover 23 are connected in the lamination direction, so that the electrode tabs 212 of the laminated cells 21 positioned in the vicinity of the cross members 333 to 335 can be appropriately cooled.

In the battery pack 1 configured as described above, since the electrode tabs 212 of the laminated cells 21 come into contact with the air circulating in the battery case 31 in the first section 51, heat from the electrode tabs 212 of the laminated cells 21 can be radiated to the second evaporator 17 through the air. As a result, the temperature of the electrode tab 212 can be lowered, and therefore it is possible to prevent occurrence of current limitation due to the temperature of the electrode tab 212, and to effectively use the capacity of the battery.

The upper portions of the laminated cells 21 radiate heat to the second evaporator 17 via the air, and the lower portions of the laminated cell 21 radiate heat to the water jacket 40 under the laminated cells 21 in the first section 51, so that temperature variation between the upper portion and the lower portion of the laminated cells 21 can be prevented.

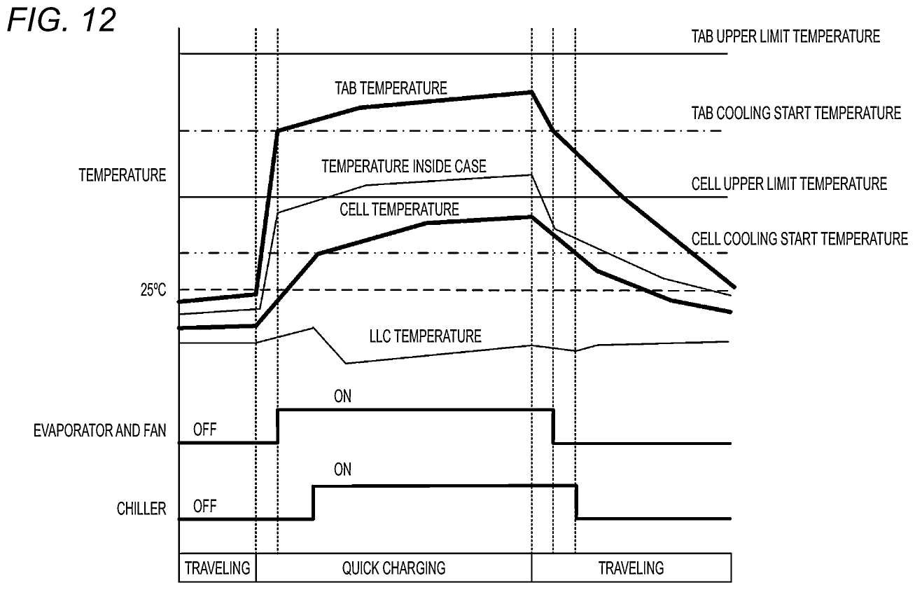

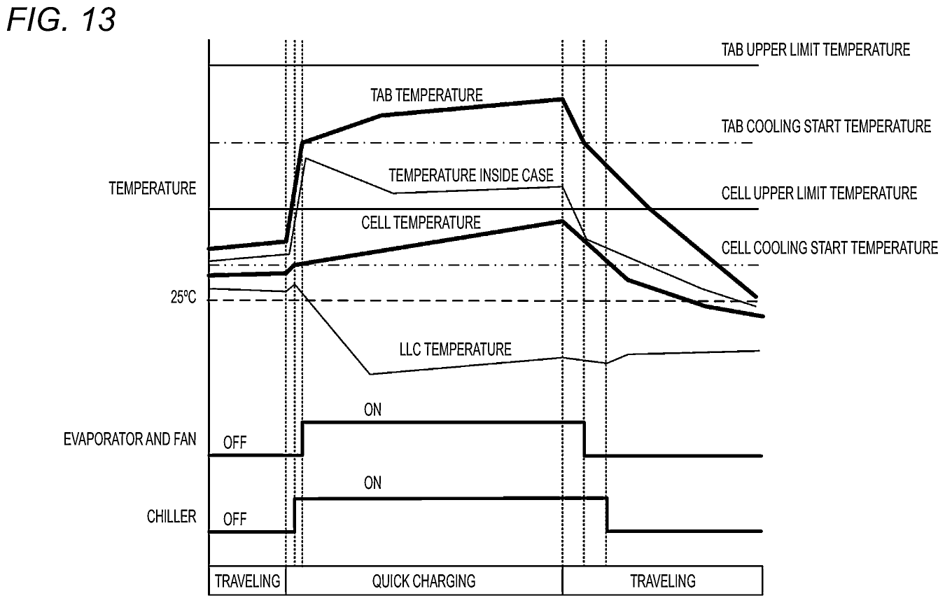

FIGS. 12 and 13 are graphs illustrating cooling control of the battery. FIG. 12 is a timing chart of battery cooling control when quick charging is started in a state in which a cell temperature is lower than the cell cooling start temperature by a predetermined value or more, and FIG. 13 is a timing chart of battery cooling control when the quick charging is started in a state in which the cell temperature is close to the cell cooling start temperature.

The control unit 14 operates the battery cooling circuit 18 in the normal mode in accordance with the start of the quick charging. As shown in FIG. 12, when the quick charging is started and the tab temperature of the laminated cell 21 reaches the tab cooling start temperature, the control unit 14 controls the second evaporator 17 and the fan 13 to the ON state. That is, when the tab temperature of the laminated cell 21 is equal to or higher than the tab cooling start temperature, the control unit 14 controls the third shut-off valve 87 of the heat pump circuit 19 to the ON state to control the second evaporator 17 to the ON state, and control the fan 13 to the ON state. As a result, an increase in the temperature inside the case is prevented, and the increase in the tab temperature also becomes gentle, so that the tab temperature is prevented from reaching a tab upper limit temperature.

Subsequently, when the cell temperature of the laminated cell 21 reaches the cell cooling start temperature, the control unit 14 controls the chiller 42 to the ON state (the above cooling mode). That is, when the cell temperature of the laminated cell 21 is equal to or higher than the cell cooling start temperature, the control unit 14 controls the second shut-off valve 85 of the heat pump circuit 19 to the ON state to control the chiller 42 to the ON state. As a result, an increase in the cell temperature is prevented when the temperature of the first refrigerant (the LLC temperature in the drawing, hereinafter referred to as a first refrigerant temperature) decreases, and the cell temperature is prevented from reaching a cell upper limit temperature.

When the quick charging is completed and the tab temperature of the laminated cell 21 becomes lower than the tab cooling start temperature, the control unit 14 controls the second evaporator 17 and the fan 13 to the OFF state. Subsequently, when the cell temperature of the laminated cell 21 becomes lower than the cell cooling start temperature, the control unit 14 controls the chiller 42 to the OFF state.

On the other hand, as shown in FIG. 13, when the quick charging is started and the cell temperature of the laminated cell 21 reaches the cell cooling start temperature, the control unit 14 controls the chiller 42 to the ON state. That is, when the cell temperature of the laminated cell 21 is equal to or higher than the cell cooling start temperature, the control unit 14 controls the second shut-off valve 85 of the heat pump circuit 19 to the ON state to control the chiller 42 to the ON state. As a result, the increase in the cell temperature is prevented when the first refrigerant temperature (the LLC temperature in the drawing) decreases, and the cell temperature is prevented from reaching the cell upper limit temperature.

Subsequently, when the tab temperature of the laminated cell 21 reaches the tab cooling start temperature, the control unit 14 controls the second evaporator 17 and the fan 13 to the ON state. That is, when the tab temperature of the laminated cell 21 is equal to or higher than the tab cooling start temperature, the control unit 14 controls the third shut-off valve 87 of the heat pump circuit 19 to the ON state to control the second evaporator 17 to the ON state, and control the fan 13 to the ON state. As a result, an increase in the temperature inside the case is prevented, and the increase in the tab temperature also becomes gentle, so that the tab temperature is prevented from reaching a tab upper limit temperature.

When the quick charging is completed and the tab temperature of the laminated cell 21 becomes lower than the tab cooling start temperature, the control unit 14 controls the second evaporator 17 and the fan 13 to the OFF state. Subsequently, when the cell temperature of the laminated cell 21 becomes lower than the cell cooling start temperature, the control unit 14 controls the chiller 42 to the OFF state.

As described above, in the battery cooling control described above, an object whose temperature is monitored differs between the cooling of the laminated cells 21 by the water jacket 40 and the cooling of the electrode tabs 212 by the air. The control unit 14 controls the battery cooling circuit 18 according to the temperatures of the laminated cells 21, so that the ability of the water jacket 40 to cool the laminated cells 21 in the first section 51 is changeable according to the temperatures of the laminated cells 21. On the other hand, since the control unit 14 controls the second evaporator 17 and the fan 13 according to the temperatures of the electrode tabs 212, the ability of the air inside the battery case 31 to cool the electrode tabs 212 is changeable according to the temperatures of the electrode tabs 212. Therefore, as compared with a case where an object whose temperature is monitored in the operation of the chiller 42 and an object whose temperature is monitored in the operation of the second evaporator 17 and the fan 13 are the same object, it is possible to more effectively prevent the occurrence of current limitation due to the temperatures of the electrode tabs 212 while maintaining the temperatures of the laminated cell 21 at an appropriate temperature.

Note that a temperature measurement method is not limited to directly measuring the temperatures of the laminated cells 21 or the temperatures of the electrode tabs 212 by bringing a temperature sensor into contact with the laminated cells 21 or the electrode tabs 212, and the temperatures of the laminated cells 21 or the electrode tabs 212 may be estimated from a temperature of a portion that reflects the temperatures of the laminated cells 21 or the electrode tabs 212. For example, the temperatures of the electrode tabs 212 may be estimated from the temperature of the air around the cell terminals. The temperatures of the laminated cells 21 may be estimated from a refrigerant temperature on an outlet side of the water jacket 40.

### Second Embodiment

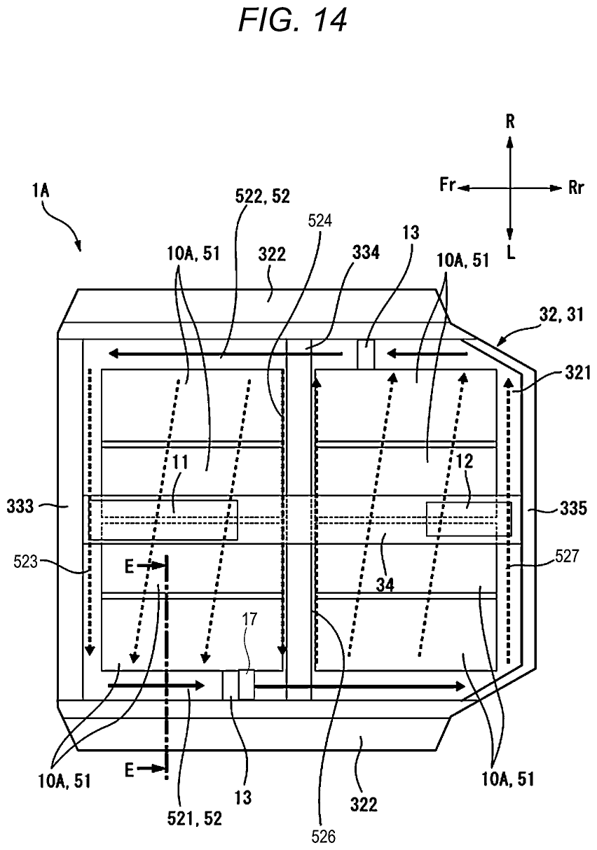

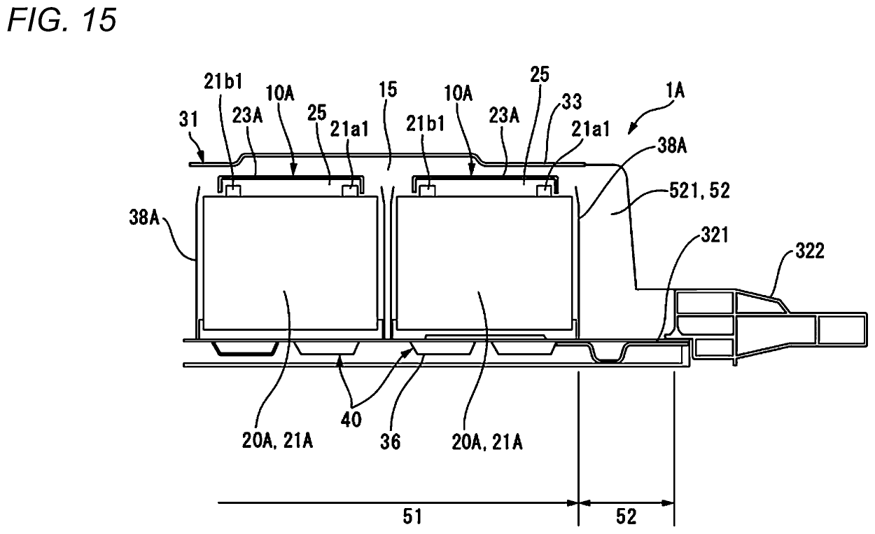

Next, a battery pack 1A according to a second embodiment will be described with reference to FIGS. 14 and 15. Note that in the following, only differences with the battery pack 1 according to the first embodiment are described. In the drawings, the same components as in the first embodiment are designated by the same reference numerals, and the description thereof will be omitted.

As shown in FIG. 14, the battery pack 1A according to the second embodiment includes eight battery modules 10A, the junction box 11, the auxiliary device 12, and the battery case 31 that accommodates the above. The eight battery modules 10A are arranged in two rows in the front-rear direction and in four rows in the left-right direction. Note that the number of the battery modules 10A can be freely set as long as there are two or more, and arrangement thereof is not particularly limited.

In the battery module 10A, a pair of end plates disposed at both end portions in a lamination direction of a cell laminate 20A in which a plurality of square cells 21A are stacked are coupled by a pair of restraining members 38A disposed on a lateral side, and a positive electrode terminal 21al and a negative electrode terminal 21b1 provided in an upper portion of the square cell 21A are covered with a bus bar cover 23A. A space 25 through which air flows is connected in the lamination direction between the positive electrode terminal 21al and the negative electrode terminal 21b1 and the bus bar cover 23A.

That is, in the battery module 10A according to the second embodiment, the positive electrode terminal 21al and the negative electrode terminal 21b1 are provided on the upper portion of the square cell 21A. Note that cylindrical cells may be laminated instead of the square cells 21A.

In the battery pack 1A configured in this way, when the second evaporator 17 and the fan 13 of the battery case 31 in which the battery modules 10A are mounted is driven, as shown by arrows in FIG. 14, similar to the arrows in FIG. 10 according to the first embodiment, the air sent out from the fan 13 on the right side flows from the front side of the right gap 522 (the positive pressure region of the fan 13 on the right side), passes through the upper portions (upper gap 15) of the four battery modules 10 positioned on the front side, flows toward the front side of the left gap 521 (the negative pressure region of the fan 13 on the left side), and is sucked into the fan 13 on the left side. The air sent out from the fan 13 on the left side flows from the rear side of the left gap 521 (the positive pressure region of the fan 13 on the left side), passes through the upper portions (upper gap 15) of the four battery modules 10 positioned on the rear side, flows toward the rear side of the right gap 522 (the negative pressure region of the fan 13 on the right side), and is sucked into the fan 13 on the right side. The air passing through the upper gap 15 cools the positive electrode terminal 21al and the negative electrode terminal 21b1 of the square cell 21A while advancing through the space 25 formed between the positive electrode terminal 21al and the negative electrode terminal 21b1 of the square cell 21A and the bus bar cover 23A and extending in the lamination direction. In this way, an upper portion of the square cells 21A (the upper portion of the battery modules 10A) can be cooled, and the positive electrode terminal 21al and the negative electrode terminal 21b1 can also be cooled.

Note that in the present embodiment, a part of the air sent out by the fan 13 also passes through the front gap 523, the central front gap 524, the rear gap 527, and the central rear gap 526. The air passing through the front gap 523, the central front gap 524, the rear gap 527, and the central rear gap 526 cools side surfaces of the square cell 21A (side surfaces of the battery module 10A).

As described above, also in the battery pack 1A, since the positive electrode terminal 21al and the negative electrode terminal 21b1 of the square cell 21A are in contact with the air circulating in the battery case 31 in the first section 51, the heat of the positive electrode terminal 21al and the negative electrode terminal 21b1 of the square cell 21A can be radiated to the second evaporator 17 in the second section 52 via the air. As a result, the temperatures of the positive electrode terminal 21al and the negative electrode terminal 21b1 can be lowered, so that it is possible to prevent the occurrence of current limitation due to the temperatures of the positive electrode terminal 21al and the negative electrode terminal 21b1, and to effectively use the capacity of the battery.

The upper portion of the square cells 21A radiates heat to the second evaporator 17 via the air, and a lower portion of the square cells 21A radiates heat to the water jacket 40 below the square cells 21A in the first section 51, so that the temperature variation between the upper portion and the lower portion of the square cell 21A can be prevented.

Although the various embodiments have been described above with reference to the drawings, it is needless to say that the present invention is not limited to these examples. It is apparent to those skilled in the art that various changes and modifications can be conceived within the scope of the claims, and it is understood that such modifications and changes naturally fall within the technical scope of the present invention. In addition, respective constituent elements in the above embodiments may be freely combined without departing from the gist of the invention.

For example, the second evaporator 17 and the fan 13 are not limited to being provided inside the battery case 31, and may be provided on the battery case 31. By providing the fan 13 on the battery case 31, air outside the battery case 31 can be taken into the battery case 31. The number of fans 13 is not limited to two, and may be one or three or more.

The water jacket 40 is not limited to being formed by the bottom plate 321 and the cover plate 36, and a separate water jacket may be attached externally or may be provided inside the battery case 31.

In this specification, at least the following matters are described. Although corresponding constituent elements or the like in the embodiments described above are shown in parentheses, the present invention is not limited thereto.

(1) A battery pack (battery pack 1, 1A) including:
a plurality of cells (laminated cells 21, square cells 21A) each having a positive electrode terminal (positive electrode tab 21a, positive electrode terminal 21a1) and a negative electrode terminal (negative electrode tab 21b, negative electrode terminal 21b1);
a plurality of battery modules (battery modules 10, 10A) in which the plurality of cells are laminated;
a battery case (battery case 31) in which the plurality of battery modules are accommodated;
a water jacket (water jacket 40) disposed on the battery case or inside the battery case and configured to allow a first refrigerant to flow therethrough and perform heat exchange with the plurality of battery modules;
a heat exchanger (second evaporator 17) disposed on the battery case or inside the battery case and configured to allow a second refrigerant to flow therethrough and perform heat exchange with air inside the battery case; and
a fan (fan 13) disposed on the battery case or inside the battery case and configured to allow air inside the battery case to circulate.

According to (1), a cell terminal comes into contact with the air circulating inside the battery case by the fan, so that heat of the cell terminal can be radiated to the heat exchanger when the air passes through the heat exchanger. In addition, a cell body radiates heat to the water jacket. As a result, it is possible to lower a temperature of the cell terminal and a temperature of the cell, and therefore it is possible to prevent the occurrence of the current limitation due to the temperature of the cell terminal, and to prevent the occurrence of the current limitation due to the temperature of the cell. Accordingly, it is possible to prevent the current limitation of the battery from working and to appropriately use the capacity of the battery.

(2) The battery pack according to (1), wherein
the water jacket cools the plurality of battery modules from below,
the battery case includes
   a first section (first section 51) in which the plurality of battery modules are disposed and heat exchange is performed between the plurality of battery modules and the water jacket,
   second sections (second section 52) which are above the water jacket and in which the plurality of battery modules are not disposed, and
   a gap (upper gap 15) which is provided between the plurality of cells and an inner wall of the battery case and configured to allow air to pass therethrough.

According to (2), air can be appropriately circulated.

(3) The battery pack according to (2), wherein
the battery case accommodates a junction box (junction box 11), and
the junction box is disposed such that air circulating through the first section and the second sections by the fan comes into contact with a conductive member of the junction box.

According to (3), the conductive member of the junction box is also cooled by the flow of air inside the battery case, and current limitation is prevented during quick charging and the like.

(4) The battery pack according to (2), wherein
the second sections are positioned outside the first section and on both sides of the first section, and
the heat exchanger and the fan are disposed in the second sections.

According to (4), the heat exchanger and the fan are installed in the second section used as a collision stroke in which the battery module is not disposed, so that a space inside the battery pack can be effectively used and an increase in the height of the battery pack can be prevented as compared with a case where the fan is installed on the battery module (the first section).

(5) The battery pack according to (4), wherein
the fan is disposed in each of the second sections,
the second sections each has
   a positive pressure region which is a side of the fan where air is discharged from the fan, and
   a negative pressure region which is a side of the fan where the air is introduced into the fan,
the positive pressure region of the second section on one side and the negative pressure region of the second section on other side face each other with the first section interposed therebetween, and
the negative pressure region of the second section on the one side and the positive pressure region of the second section on the other side face each other with the first section interposed therebetween.

According to (5), a pressure distribution is formed in the positive pressure region of the second section, the first section (the battery module), and the negative pressure region of the second section, and circulation of air inside the battery case can be more smoothly made.

(6) The battery pack according to (1), wherein
the plurality of battery modules include a terminal insulating cover (bus bar covers 23, 23A) that covers at least one cell terminal (electrode tab 212) of the positive electrode terminals and the negative electrode terminals of the cells, and
a space (space 25) extending in a lamination direction of the cells is provided between the terminal insulating cover and the cell terminal.

According to (6), the space around the cell terminals becomes an air path, so that the cell terminal can be efficiently cooled while being insulated.

(7) The battery pack according to (2), wherein
the second sections are positioned outside the first section and on both sides of the first section, and
an air path (front gap 523, central front gap 524, central rear gap 526, rear gap 527) orthogonal to an extending direction of the second section and connecting the second section on one side and the second section on other side is formed between the battery modules adjacent to each other, or between the battery module and a cross member (front cross member 333, central cross member 334, rear cross member 335).

When there are cell terminals on both sides of the cell, a position of one terminal is positioned on a side closer to the other battery module or the cross member. According to (7), by providing the air path between adjacent battery modules or between the battery module and the cross member, compared to placing battery modules in close contact with each other without providing air paths, the cell terminals near other battery modules and cross members can also be efficiently cooled.

(8) A battery cooling system (battery cooling system 100) including:
the battery pack according to any one of (1) to (7);
a refrigerant circuit (battery cooling circuit 18) configured to allow the first refrigerant flowing through the water jacket to circulate;
a heat pump circuit (heat pump circuit 19) configured to allow the second refrigerant flowing through the heat exchanger to circulate;
a second heat exchanger (chiller 42) configured to perform heat exchange between the first refrigerant and the second refrigerant; and
a control unit (control unit 14) configured to control the heat exchanger, the second heat exchanger, and the fan.

According to (8), the first refrigerant radiates heat to the heat pump circuit via the second refrigerant in the second heat exchanger, and the air inside the battery case also radiates heat to the heat exchanger of the heat pump circuit, so that the inside of the battery case can be appropriately cooled with one heat pump circuit.

(9) The battery cooling system according to (8), wherein
the control unit
   controls the second heat exchanger to an ON state when a temperature of the cell is higher than a first threshold (cell cooling start temperature), and
   controls the heat exchanger and the fan to an ON state when a terminal temperature of the cell is higher than a second threshold (tab cooling start temperature).

According to (9), an object whose temperature is monitored differs between the cooling of the cell by the water jacket and the cooling of the cell terminal by the air, and the ability of the water jacket to cool the cell changes depending on the temperature of the cell, and the ability of the air inside the battery case to cool the cell terminal changes depending on the temperature of the cell terminal. As a result, it is more effective to prevent the occurrence of current limitation due to the temperature of the cell terminal while maintaining the temperature of the cell at an appropriate temperature. Note that a temperature measurement method is not limited to directly measuring the temperature of the cell or the temperature of the cell terminal by bringing a temperature sensor into contact with the cell or the cell terminal, and the temperature of the cell or the cell terminal may be estimated from a temperature of a portion that reflects the temperature of the cell or the cell terminal. For example, the temperature of the cell terminal may be estimated from the temperature of the air around the cell terminal. The temperature of the cell may be estimated from a refrigerant temperature on an outlet side of the water jacket.

(10) The battery cooling system according to (8), wherein

the heat pump circuit has, upstream of a flow path flowing to the second heat exchanger, a branch portion (second branch portion 83) to the flow path flowing to the heat exchanger.

According to (10), since the branch portion is positioned upstream of the second heat exchanger, the second refrigerant to be cooled before the heat exchange in the second heat exchanger can be supplied to the heat exchanger.

### REFERENCE SIGNS LIST

1, 1A battery pack
10, 10A battery module
11 junction box
13 fan
14 control unit
15 upper gap (gap)
17 second evaporator (heat exchanger)
18 battery cooling circuit (refrigerant circuit)
19 heat pump circuit
21 laminated cell (cell)
21A square cell (cell)
21a positive electrode tab (positive electrode terminal)
21al positive electrode terminal (positive electrode terminal)
21b negative electrode tab (negative electrode terminal)
21b1 negative electrode terminal (negative electrode terminal)
23, 23A bus bar cover (terminal insulating cover)
25 space
31 battery case
33 upper cover (cover)
40 water jacket
42 chiller (second heat exchanger)
51 first section
52 second section
60 cover plate (terminal insulating cover)
83 second branch portion (branch portion)
100 battery cooling system
212 electrode tab (cell terminal)
523 front gap (air path)
524 central front gap (air path)
526 central rear gap (air path)
527 rear gap (air path)

What is claimed is:

1. A battery pack comprising:
a plurality of cells each having a positive electrode terminal and a negative electrode terminal;
a plurality of battery modules in which the plurality of cells are laminated;
a battery case in which the plurality of battery modules are accommodated;
a water jacket disposed on the battery case or inside the battery case and configured to allow a first refrigerant to flow through the water jacket and perform heat exchange with the plurality of battery modules;
a heat exchanger disposed on the battery case or inside the battery case and configured to allow a second refrigerant to flow through the heat exchanger and perform heat exchange with air inside the battery case; and
a fan disposed on the battery case or inside the battery case and configured to allow air inside the battery case to circulate.

2. The battery pack according to claim 1, wherein
the water jacket cools the plurality of battery modules from below,
the battery case includes
a first section in which the plurality of battery modules are disposed and heat exchange is performed between the plurality of battery modules and the water jacket,
second sections which are above the water jacket and in which the plurality of battery modules are not disposed, and
a gap which is provided between the plurality of cells and an inner wall of the battery case and configured to allow air to pass through the gap.

3. The battery pack according to claim 2, wherein
the battery case accommodates a junction box, and
the junction box is disposed such that air circulating through the first section and the second sections by the fan comes into contact with a conductive member of the junction box.

4. The battery pack according to claim 2, wherein
the second sections are positioned outside the first section and on both sides of the first section, and
the heat exchanger and the fan are disposed in the second sections.

5. The battery pack according to claim 4, wherein
the fan is disposed in each of the second sections,
the second sections each has
a positive pressure region which is a side of the fan where air is discharged from the fan, and
a negative pressure region which is a side of the fan where the air is introduced into the fan,
the positive pressure region of the second section on one side and the negative pressure region of the second section on other side face each other with the first section interposed therebetween, and
the negative pressure region of the second section on the one side and the positive pressure region of the second section on the other side face each other with the first section interposed therebetween.

6. The battery pack according to claim 1, wherein
the plurality of battery modules include a terminal insulating cover that covers at least one cell terminal of the positive electrode terminals and the negative electrode terminals of the cells, and
a space extending in a lamination direction of the cells is provided between the terminal insulating cover and the cell terminal.

7. The battery pack according to claim 2, wherein
the second sections are positioned outside the first section and on both sides of the first section, and
an air path orthogonal to an extending direction of the second sections and connecting the second section on one side and the second section on other side is provided between the battery modules adjacent to each other, or between the battery modules and a cross member.

8. A battery cooling system comprising:
the battery pack according to claim 1;
a refrigerant circuit configured to allow the first refrigerant flowing through the water jacket to circulate;
a heat pump circuit configured to allow the second refrigerant flowing through the heat exchanger to circulate;
a second heat exchanger configured to perform heat exchange between the first refrigerant and the second refrigerant; and
a controller configured to control the heat exchanger, the second heat exchanger, and the fan.

9. The battery cooling system according to claim 8, wherein
the controller
controls the second heat exchanger to an ON state when a temperature of the cell is higher than a first threshold, and
controls the heat exchanger and the fan to an ON state when a terminal temperature of the cell is higher than a second threshold.

10. The battery cooling system according to claim 8, wherein
the heat pump circuit has, upstream of a flow path flowing to the second heat exchanger, a branch portion to the flow path flowing to the heat exchanger.
